(19) United States
(12) Patent Application Publication
(10) Pub. No.: US 2014/0318577 A1
(43) Pub. Date: Oct. 30, 2014

(54) APPARATUSES AND METHODS FOR REMOVING DEPOSITS IN THERMAL CONVERSION PROCESSES

(71) Applicant: UOP LLC, Des Plaines, IL (US)

(72) Inventor: Sathit Kulprathipanja, Schaumburg, IL (US)

(21) Appl. No.: 13/870,876

(22) Filed: Apr. 25, 2013

(51) Int. Cl. B08B 9/045

(52) U.S. Cl. CPC B08B 9/045
USPC 134/8; 15/104.02

(57) ABSTRACT

Embodiments of apparatuses and methods for removing deposits in thermal conversion processes are provided herein. In one example, a method comprises advancing a hot vapor through a hot vapor inlet tubular section to a low temperature zone inlet nozzle of a longitudinal tubular section. The hot vapor inlet tubular section has a first inner diameter and the longitudinal tubular section has a second inner diameter that is greater than the first inner diameter. A ram head with a net open cross-sectional flow area is moved between a retracted position and an extended position to remove the deposits in the low temperature zone inlet nozzle.

### STATEMENT REGARDING FEDERALLY SPONSORED RESEARCH OR DEVELOPMENT

This invention was made with Government support under DE-EE0002879 awarded by the U.S. Department of Energy. The Government has certain rights in this invention.

### TECHNICAL FIELD

The technical field relates generally to thermal conversion processes, and more particularly relates to apparatuses and methods for removing deposits in thermal conversion processes such as in pyrolysis processes including rapid thermal processes.

### BACKGROUND

The thermal conversion processing of carbonaceous feedstocks (e.g. biomass) to produce chemicals and/or fuels can be accomplished by fast (rapid or flash) pyrolysis. Fast pyrolysis is a generic term that encompasses various methods of rapidly imparting a relatively high temperature to feedstocks for a very short time, and then rapidly reducing the temperature of the primary products before chemical equilibrium can occur. Using this approach, the complex structures of carbonaceous feedstocks are broken into reactive chemical fragments, which are initially formed by depolymerization and volatilization reactions. The non-equilibrium products are then preserved by rapidly reducing the temperature.

More recently, a rapid thermal process (RTP) has been developed for carrying out fast pyrolysis of carbonaceous material. The RTP utilizes an upflow transport reactor and makes use of an inert inorganic solid particulate heat carrier (e.g. typically sand) to carry and transfer heat in the process. The RTP reactor provides an extremely rapid heating rate and excellent particle ablation of the carbonaceous material, which is particularly well-suited for processing of biomass, as a result of direct turbulent contact between the heated inorganic solid particulates and the carbonaceous material as they are mixed together and travel upward through the reactor. In particular, the heated inorganic solid particulates transfer heat to pyrolyze the carbonaceous material (e.g., temperatures of 500° C. or greater) forming char and gaseous products including a condensable high quality pyrolysis gas. A reactor cyclone then separates the gaseous products and solids (e.g. inorganic solid particulates and char).

The gaseous byproducts including the condensable high quality pyrolysis gas will continue to react as long as they remain at elevated temperatures in the vapor phase and therefore, need to be quickly cooled or “quenched” to preserve, in particular, the condensable high quality pyrolysis gas. As such, the gaseous byproducts from the reactor cyclone are rapidly advanced through a transfer line(s) (e.g., pipeline) to a low temperature zone (e.g., quench tower) for rapid cooling to a temperature of less than 100° C., for example. As rapid cooling is effected, certain components in the gaseous byproducts (particularly the heavier fractions) tend to quickly condense on cooler surfaces including along the transfer line, causing coke-like deposits to form on these surfaces. Over a relatively short period of time (e.g., hours), these deposits can build up causing a higher pressure drop between the high temperature zone (e.g., reactor cyclone and/or reactor) and the low temperature zone, resulting in hydraulic back pressure and reduced flow rate of the gaseous byproducts to the low temperature zone for quenching. Unfortunately, current apparatuses and methods for removing these deposits along the transfer line can cause an undesirable hydraulic bounce (e.g., sudden change in hydraulic pressure) and/or disruption of the unit operations (e.g., particularly in the high temperature zone) during removal of the deposits.

Accordingly, it is desirable to provide apparatuses and methods for removing deposits in thermal conversion processes while minimizing or preventing a hydraulic bounce and/or disruption of the unit operations during removal of the deposits. Furthermore, other desirable features and characteristics of the present invention will become apparent from the subsequent detailed description and the appended claims, taken in conjunction with the accompanying drawings and this background.

### BRIEF SUMMARY

Apparatuses and methods for removing deposits in thermal conversion processes are provided herein. In accordance with an exemplary embodiment, an apparatus for removing deposits in a thermal conversion process comprises a branched pipeline for fluidly communicating between a high temperature zone and a low temperature zone. The branched pipeline comprises a longitudinal tubular section that extends distally to define a low temperature zone inlet nozzle. A hot vapor inlet tubular section extends from the longitudinal tubular section proximal the low temperature zone inlet nozzle. The hot vapor inlet tubular section has a first inner diameter that defines a hot vapor channel that is formed through the hot vapor inlet tubular section. The longitudinal tubular section has a second inner diameter that is greater than the first inner diameter. The second inner diameter defines a longitudinal channel that is open to the hot vapor channel and that extends through the low temperature zone inlet nozzle. A reamer comprises a ram head with a net open cross-sectional flow area. The ram head is operably disposed in the longitudinal channel to move between a retracted position and an extended position to remove the deposits in the low temperature zone inlet nozzle.

In accordance with another exemplary embodiment, an apparatus for removing deposits in a thermal conversion process is provided. The apparatus comprises a branched pipeline for fluidly communicating between a high temperature zone and a low temperature zone. The branched pipeline comprises a longitudinal tubular section that extends distally to define a low temperature zone inlet nozzle. A hot vapor inlet tubular section extends from the longitudinal tubular section proximal the low temperature zone inlet nozzle. The hot vapor inlet tubular section has a hot vapor channel formed therethrough with a first cross-sectional flow area. The longitudinal tubular section has a longitudinal channel that is open to the hot vapor channel and extends through the low temperature zone inlet nozzle. A reamer comprises a ram head with a net open cross-sectional flow area. The ram head is operably disposed in the longitudinal channel to move between a retracted position and an extended position to remove the deposits in the low temperature zone inlet nozzle. The ram head has a tubular wall with a slot opening formed therethrough. The slot opening has a slot opening flow area that is greater than the first cross-sectional flow area of the hot vapor channel.

In accordance with another exemplary embodiment, a method for removing deposits in a thermal conversion process is provided. The method comprises the steps of advancing a hot vapor through a hot vapor inlet tubular section to a low temperature zone inlet nozzle of a longitudinal tubular section. The hot vapor inlet tubular section has a first inner diameter and the longitudinal tubular section has a second inner diameter that is greater than the first inner diameter. A ram head with a net open cross-sectional flow area is moved between a retracted position and an extended position to remove the deposits in the low temperature zone inlet nozzle.

### BRIEF DESCRIPTION OF THE DRAWINGS

The various embodiments will hereinafter be described in conjunction with the following drawing figures, wherein like numerals denote like elements, and wherein:

FIG. 1 is a perspective view of an apparatus for removing deposits in a thermal conversion process in accordance with an exemplary embodiment;

FIG. 2 is a sectional side view of an apparatus including a ram head for removing deposits in a thermal conversion process in accordance with an exemplary embodiment;

FIG. 3 is a top view of the ram head depicted in FIG. 2 viewed in the direction of line 3;

FIG. 4 is a front view of the ram head depicted in FIG. 2 viewed in the direction of line 4; and

FIG. 5 is a side view of the ram head depicted in FIG. 4 viewed in the direction of line 5.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

Various embodiments contemplated herein relate to apparatuses and methods for removing deposits in a thermal conversion process such as in a pyrolysis process, e.g., a rapid thermal process (RTP). The exemplary embodiments taught herein provide a branched pipeline that provides fluid communication between a high temperature zone (e.g., reactor cyclone that is fluidly coupled to a RTP reactor) and a low temperature zone (e.g., quenching tower). The branched pipeline includes a longitudinal tubular section that extends distally to define a low temperature zone inlet nozzle. The low temperature zone inlet nozzle is fluidly coupled to the low temperatures zone. A hot vapor inlet tubular section extends from the longitudinal tubular section proximal to the low temperature zone inlet nozzle. The hot vapor tubular section is fluidly coupled to the high temperature zone to receive hot vapor (e.g., RTP gaseous products including a condensable high quality pyrolysis gas at a temperature of about 500° C. or greater).

In an exemplary embodiment, the hot vapor inlet tubular section has a first inner diameter that defines a hot vapor channel that is formed through the hot vapor inlet tubular section. The longitudinal tubular section has a second inner diameter that is greater than the first inner diameter. The second inner diameter defines a longitudinal channel that is open to the hot vapor channel and that extends through the low temperature zone inlet nozzle. A reamer for removing deposits includes a ram head. The ram head has a net open cross-sectional flow area. The ram head is operably disposed in the longitudinal channel to move between a retracted position and an extended position.

In an exemplary embodiment, the hot vapor from the high temperature zone is advanced through a hot vapor inlet tubular section to the low temperature zone inlet nozzle for introduction to the low temperature zone to quench the hot vapor, for example, to a temperature of about 100° C. or less. Over time, coke-like deposits form along the inner surfaces of the longitudinal tubular section adjacent to the low temperature zone including along the inner surfaces of the low temperature zone inlet nozzle. The ram head is moved from a retracted position to an extended position to remove these deposits. Because the ram head has the net open cross-sectional flow area, the hot vapor is able to pass through the ram head during removal of the deposits to reduce or minimize any incremental back pressure that might otherwise cause a substantial hydraulic bounce and/or disruption to the thermal conversion process. Additionally, in an exemplary embodiment, because the longitudinal channel has a greater inner diameter than the hot vapor channel, the ram head can be sized relatively large compared to the hot vapor channel such that the net open cross-sectional flow area is about the same as or greater than the cross-sectional flow area of the hot vapor to further reduce or prevent any incremental back pressure that can cause a substantial hydraulic bounce and/or disruption of the thermal conversion process.

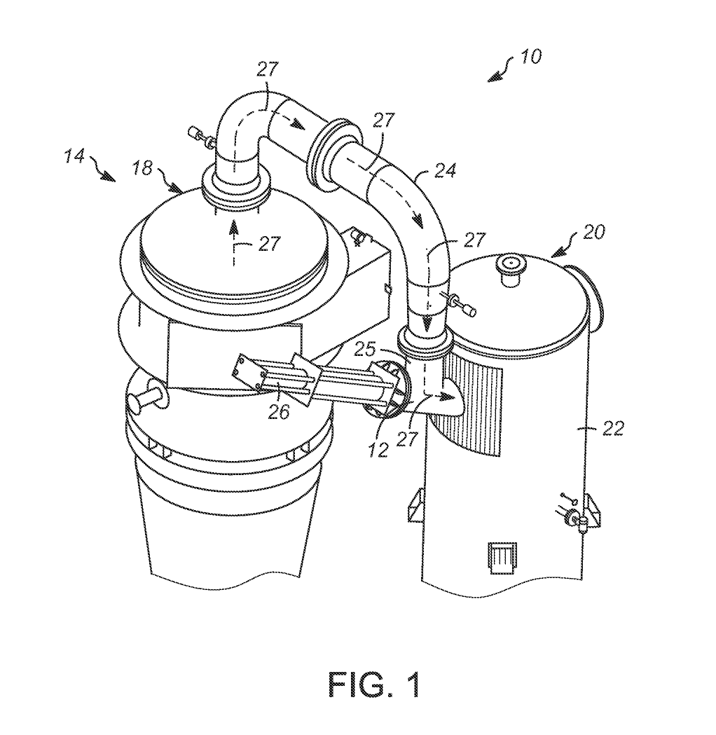

Referring to FIG. 1, a portion of a thermal conversion arrangement 10 including an apparatus 12 for removing deposits in the thermal conversion arrangement 10 in accordance with an exemplary embodiment is provided. As illustrated, the thermal conversion arrangement 10 includes a high temperature zone 14 that includes a reactor cyclone 18, a low temperature zone 20 that includes a primary quench tower 22, and the apparatus 12 that is fluidly coupled to both the high temperature zone 14 via a pipeline 24 and to the low temperature zone 20. As illustrated and will be discussed in further detail below, the apparatus 12 includes a branched pipeline 25 and a reamer 26.

The reactor cyclone 18 separates a hot vapor (indicated by dashed arrows 27) from heated inorganic solid particles (e.g., sand) that is used to thermally convert a carbonaceous material (e.g., biomass) into the hot vapor 27 in the RTP reactor. (not shown) which is directly attached to the reactor cyclone In an exemplary embodiment, the hot vapor 27 has a temperature of about 500° C. or greater, such as from about 500 to about 650° C.

The hot vapor 27 is advanced through the pipelines 24 and 25 for introduction to the primary quench tower 22. The primary quench tower 22 quickly quenches the majority of the condensable pyoil in the incoming hot vapor 27 into a liquid pyoil product, which creates a hot-cold interface zone. In an exemplary embodiment, the hot vapor 27 is quenched in the primary quench tower 22 to a temperature of about 100° C. or less, such as from about 50 to about 100° C. to form the liquid product. As will be discussed in further detail below, the reamer 26 removes coke-like deposits and other product deposits that form along portions of the branched pipeline 25 due to the hot-cold interface zone, thereby preventing unwanted increases in system back pressure.

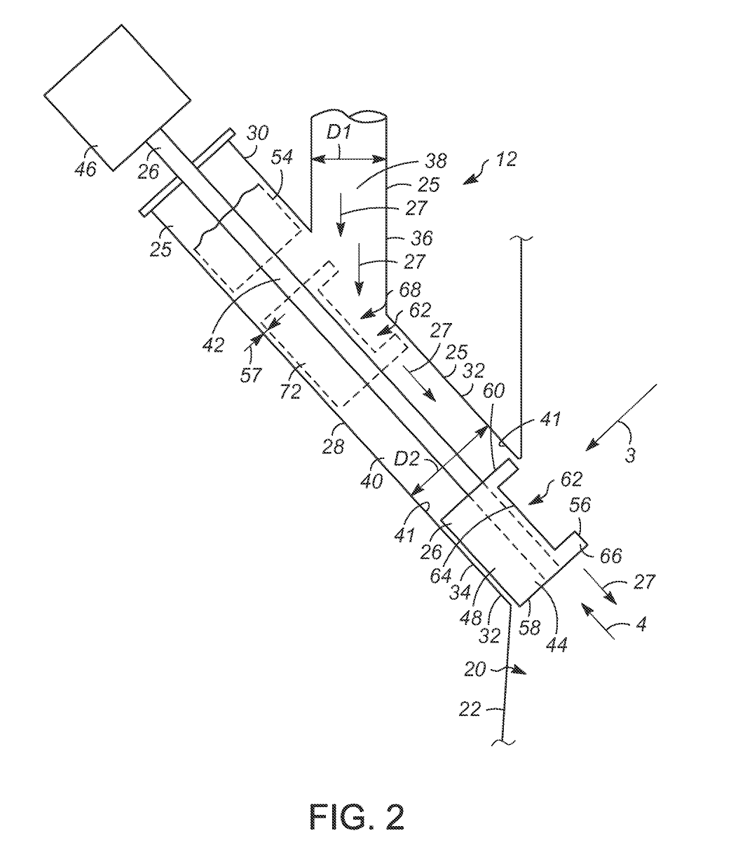

Referring to FIG. 2, a sectional side view of the apparatus 12 in accordance with an exemplary embodiment is provided. The branched pipeline 25 of the apparatus 12 includes a longitudinal tubular section 28 that extends from a proximal section 30 to a distal section 32. The distal section 32 of the longitudinal tubular section 28 forms a low temperature zone inlet nozzle 34 that is fluidly coupled to the low temperature zone 20. A hot vapor inlet tubular section 36 extends from the longitudinal tubular section 28 proximal the low temperature zone inlet nozzle 34 and is fluidly coupled to the pipeline 24 (see FIG. 1).

In an exemplary embodiment, the hot vapor inlet tubular section 36 has an inner diameter (indicated by double headed arrow D1) that defines a hot vapor channel 38 having a relatively circular cross-sectional flow area. As such, the cross-sectional flow area of the hot vapor channel 38 corresponds to about π(D1)²/4.

In an exemplary embodiment, the longitudinal tubular section 28 has an inner diameter (indicated by double headed arrow D2) that defines a longitudinal channel 40 having a relatively circular cross-sectional flow area. Likewise, the cross-sectional flow area of the longitudinal channel 40 corresponds to about π(D2)²/4.

The inner diameter D2 and the corresponding net cross-sectional flow area of the longitudinal channel 40 are greater than the inner diameter D1 and the corresponding cross-sectional flow area of the hot vapor inlet tubular section 36, respectively. In an exemplary embodiment, the inner diameter D2 is about 105% or greater of the inner diameter D1, such as from about 105 to about 150% of the inner diameter D1.

As illustrated, the longitudinal channel 40 is open to the hot vapor channel 38 and extends through the low temperature zone inlet nozzle 34. This allows the hot vapor 27 from the high temperature zone 14 (see FIG. 1) to pass through the hot vapor channel 38, the longitudinal channel 40 including the low temperature zone inlet nozzle 34, to the low temperature zone 20. The hot-cold interface zone adjacent to the low temperature zone 20 extends along the inner surfaces 41 of the low temperature zone inlet nozzle 34 and, as such, coke-like deposits and other product deposits can build up along these inner surfaces 41.

The reamer 26 includes a rod 42 and a ram head 44. The ram head 44 is operably coupled to a distal end section of the rod 42 and the proximal end section of the rod 42 is operably coupled to an actuator 46.

Referring also to FIG. 4, in an exemplary embodiment, the ram head 44 has a tubular wall 48 that is disposed substantially coaxial with the longitudinal tubular section 28 and that surrounds a ram head channel 50. A plurality of spokes 52 are disposed in the ram head channel 50 and extend radially outward from the rod 42 to operably couple the tubular wall 48 with the rod 42. The actuator 46 is configured to move the rod 42 together with the ram head 44 through the longitudinal channel 40 between a retracted position 54 and an extended position 56.

As illustrated in FIG. 2, a gap (indicated by arrows 57) is formed between the tubular wall 48 and an inner surface of the longitudinal tubular section 28. In an exemplary embodiment, the gap 57 is about 2 mm or greater, such as from about 2 to about 4 mm.

As illustrated in FIGS. 2 and 4, the ram head channel 50 extends longitudinally through ram head 44 such that both the distal end 58 and the proximal end 60 of the ram head 44 are open. As such, the ram head 44 has a net cross-sectional flow area 61 to allow the hot vapor 27 to pass through the ram head 44 while the ram head 44 is being moved between the retracted and extended positions 54 and 56. In an exemplary embodiment, the net open cross-sectional flow area 61 of the ram head 44 is defined as a cross-sectional area of the ram head channel 50 less a combined cross-sectional area of the rod 42 and the spokes 52. In an exemplary embodiment, the net open cross-sectional flow area 61 is about 100% or greater, such as from about 100 to about 110%, of the cross-sectional flow area of the hot vapor inlet tubular section 36.

Referring to FIGS. 2, 3, and 5, in an exemplary embodiment, a slot opening 62 is formed through an intermediate section 64 of the tubular wall 48 between a leading continuous edge section 66 and a trailing continuous edge section 68. In an exemplary embodiment, for structure, the leading and trailing continuous edge sections 66 and 68 of the ram head 44 have corresponding minimum longitudinal lengths (indicated by arrows L1 and L2) of at least about 5 mm, such as from about 5 to about 25 mm. As illustrated, the leading continuous edge section 66 has a leading beveled edge 69 to facilitate removing the deposits.

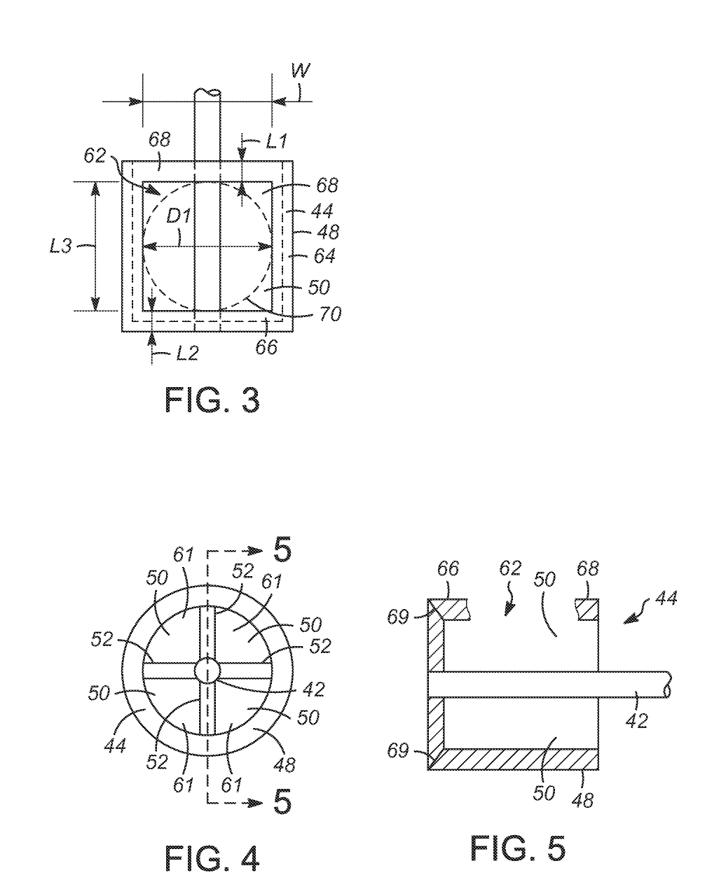

In an exemplary embodiment, the slot opening 62 has a slot opening flow area 68 that is defined by a length (indicated by double headed arrow L3) and a width (indicated by arrows W). In an exemplary embodiment, the slot opening flow area 68 is greater than the cross-sectional flow area (indicated in FIG. 3 by dashed lines 70) of the hot vapor channel 38. In one example, the slot opening flow area 68 is about 105% or greater, such as from about 105 to about 150%, of the cross-sectional flow area 70 of the hot vapor chamber 38. In an exemplary embodiment, the length L3 and width W of the slot opening flow area 68 are independently about the same as or greater than the inner diameter D1 of the hot vapor inlet tubular section 36. In another exemplary embodiment, the slot opening 62 is positioned along the tubular wall 48 such that when the ram head 44 is in an intermediate position 72, the slot opening 62 and the hot vapor channel 38 are matched and aligned to allow the hot vapor 27 from the hot vapor inlet tubular section 36 to pass through the slot opening 62 into the ram head channel 50 and the longitudinal channel 40 substantially unobstructed.

Accordingly, apparatuses and methods for removing deposits in a thermal conversion process have been described. The exemplary embodiments taught herein provide a branched pipeline that provides fluid communication between a high temperature zone and a low temperature zone. The branched pipeline includes a longitudinal tubular section that extends distally to define a low temperature zone inlet nozzle. A hot vapor inlet tubular section extends from the longitudinal tubular section proximal to the low temperature zone inlet nozzle. In an exemplary embodiment, the hot vapor inlet tubular section has a first inner diameter that defines a hot vapor channel that is formed through the hot vapor inlet tubular section. The longitudinal tubular section has a second inner diameter that is greater than the first inner diameter. The second inner diameter defines a longitudinal channel that is open to the hot vapor channel and that extends through the low temperature zone inlet nozzle. A reamer for removing deposits includes a ram head. The ram head has a net open cross-sectional flow area. The ram head is operably disposed in the longitudinal channel to move between a retracted position and an extended position. Because the ram head has the net open cross-sectional flow area, the hot vapor is able to pass through the ram head during removal of the deposits to reduce or minimize any incremental back pressure that might otherwise cause a substantial hydraulic bounce and/or disruption to the thermal conversion process.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. An apparatus for removing deposits in a thermal conversion process, the apparatus comprising:
a branched pipeline for fluidly communicating between a high temperature zone and a low temperature zone, wherein the branched pipeline comprises:
a longitudinal tubular section that extends distally to define a low temperature zone inlet nozzle; and
a hot vapor inlet tubular section that extends from the longitudinal tubular section proximal the low temperature zone inlet nozzle, wherein the hot vapor inlet tubular section has a first inner diameter that defines a hot vapor channel that is formed through the hot vapor inlet tubular section and the longitudinal tubular section has a second inner diameter that is greater than the first inner diameter and that defines a longitudinal channel open to the hot vapor channel and extending through the low temperature zone inlet nozzle; and
a reamer comprising;
a ram head with a net open cross-sectional flow area and operably disposed in the longitudinal channel to move between a retracted position and an extended position to remove the deposits in the low temperature zone inlet nozzle.

2. The apparatus of claim 1, wherein the second inner diameter is about 105% or greater of the first inner diameter.

3. The apparatus of claim 1, wherein the second inner diameter is from about 105 to about 150% of the first inner diameter.

4. The apparatus of claim 1, wherein the first inner diameter defines a first cross-sectional flow area of the hot vapor channel, and wherein the net open cross-sectional flow area is about 100% or greater of the first cross-sectional flow area.

5. The apparatus of claim 4, wherein the net open cross-sectional flow area is from about 100 to about 110% of the first cross-sectional flow area.

6. The apparatus of claim 1, wherein the ram head has a tubular wall that is disposed substantially coaxial with the longitudinal tubular section and that surrounds a ram head channel.

7. The apparatus of claim 6, wherein the reamer further comprises:
a rod disposed in the ram head channel and extending longitudinally in the longitudinal tubular section in a proximal direction; and
a plurality of spokes disposed in the ram head channel and extending radially outward from the rod to operably coupled the rod with the tubular wall to move the tubular wall in unison with the rod between the retracted and extended positions.

8. The apparatus of claim 7, wherein the net open cross-sectional flow area is defined as a cross-sectional area of the ram head channel less a combined cross-sectional area of the rod and the plurality of spokes.

9. The apparatus of claim 6, wherein the tubular wall has a slot opening formed therethrough.

10. The apparatus of claim 9, wherein the first inner diameter defines a first cross-sectional flow area of the hot vapor channel, and the slot opening defines a slot opening flow area that is greater than the first cross-sectional flow area.

11. The apparatus of claim 9, wherein the slot opening has a length and a width that are each about the same as or greater than the first inner diameter.

12. The apparatus of claim 6, wherein the tubular wall has a leading beveled edge to facilitate removing the deposits.

13. An apparatus for removing deposits in a thermal conversion process, the apparatus comprising:
a branched pipeline for fluidly communicating between a high temperature zone and a low temperature zone, wherein the branched pipeline comprises:
a longitudinal tubular section that extends distally to define a low temperature zone inlet nozzle; and
a hot vapor inlet tubular section that extends from the longitudinal tubular section proximal the low temperature zone inlet nozzle, wherein the hot vapor inlet tubular section has a hot vapor channel formed therethrough with a first cross-sectional flow area and the longitudinal tubular section has a longitudinal channel open to the hot vapor channel and extending through the low temperature zone inlet nozzle; and
a reamer comprising a ram head with a net open cross-sectional flow area, wherein the ram head is operably disposed in the longitudinal channel to move between a retracted position and an extended position to remove the deposits in the low temperature zone inlet nozzle, wherein the ram head has a tubular wall with a slot opening formed therethrough, and wherein the slot opening has a slot opening flow area that is greater than the first cross-sectional flow area of the hot vapor channel.

14. The apparatus of claim 13, wherein the slot opening is positioned in the tubular wall such that during movement of the ram head between the retracted and extended positions the slot opening and the hot vapor channel are matched and aligned to allow hot vapor from the hot vapor inlet tubular section to pass through the slot opening substantially unobstructed into the longitudinal channel.

15. The apparatus of claim 13, wherein the slot opening is formed through an intermediate section of the tubular wall between a leading continuous edge section and a trailing continuous edge section.

16. The apparatus of claim 15, wherein the leading and trailing continuous edge sections each have a minimum longitudinal length of at least about 5 mm.

17. The apparatus of claim 13, wherein the slot opening flow area is about 105% or greater of the first cross-sectional flow area.

18. The apparatus of claim 13, wherein the net open cross-sectional flow area is about 100% or greater of the first cross-sectional flow area.

19. The apparatus of claim 13, wherein a gap of about 2 mm or greater is formed between the tubular wall and an inner surface of the longitudinal tubular section.

20. A method for removing deposits in a thermal conversion process, the method comprising the steps of:
advancing a hot vapor through a hot vapor inlet tubular section that has a first inner diameter to a low temperature zone inlet nozzle of a longitudinal tubular section that has a second inner diameter that is greater than the first inner diameter; and
moving a ram head with a net open cross-sectional flow area between a retracted position and an extended position to remove the deposits in the low temperature zone inlet nozzle.
